(19) United States
(12) Patent Application Publication
(10) Pub. No.: US 2007/0083601 A1
(43) Pub. Date: Apr. 12, 2007

(54) MOBILE TERMINAL CAPABLE OF CANCELING RESERVED TRANSMISSION OF MMS (MULTIMEDIA MESSAGE SERVICE) MESSAGE AND METHOD FOR USE IN THE SAME

(75) Inventor: Moon Sun Kim, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/539,864

(22) Filed: Oct. 9, 2006

(30) Foreign Application Priority Data
Oct. 10, 2005 (KR) 10-2005-0094984

(51) Int. Cl. G06F 15/16

(52) U.S. Cl. 709/206; 709/203

(57) ABSTRACT

A mobile terminal for canceling a reserved transmission of a multimedia message service (MMS) message, and a method for use in the same are disclosed. The mobile terminal includes: a controller to receive a reserved transmission cancellation request of an MMS message, and generating a request signal to cancel the MMS message reserved transmission; and a transmitting unit to transmit the generated request signal to a message provision server.

This application claims the benefit of Korean Patent Application No. 10-2005-0094984, filed on Oct. 10, 2005, which is hereby incorporated by reference as if fully set forth herein.

### BACKGROUND OF THE INVENTION

1. Field of the Invention

The present invention relates to a multimedia message service (MMS) message of a mobile terminal, and more particularly to a reserved transmission MMS message.

2. Discussion of the Related Art

Recently, a variety of wired or wireless message services, for example, a Short Message Service (SMS), an E-mail service, and a Multimedia Message Service (MMS), have been widely used throughout the world by wire or wirelessly.

The above-mentioned message services have a variety of convenient functions. Specifically, a reserved transmission function is available for individual message services. The reserved transmission function allows a user to transmit a pre-written message at a desired time (i.e., a reserved time), such that it is considered to be the most convenient function from among the message service functions.

As described above, the reserved transmission function allows a specific Web server to manage a reserved transmission message pre-written by the user via a Web-site of a enterprise, and transmits the pre-written reserved transmission message when a current time reaches a reserved transmission time prescribed in the above-mentioned reserved transmission message.

In addition, the user can freely cancel a reserved transmission command for a reserved transmission message via a Web-site at any time.

Although the above reserved message transmission and the above reserved message cancellation are generally executed via a Web-site by wire, mobile environments do not provide users or subscribers with message services via a Web-site due to limitations of a wireless scheme.

Thereafter, a reserved transmission method for a message supported by mobile environments will hereinafter be described with reference to FIG. 1.

A Multimedia Message Service (MMS) available for mobile environments can perform an MMS reserved transmission function according to specifications (3GPP. TS. 23. 140) prescribed in 3GPP.

FIG. 1 is a flow chart illustrating a conventional reserved MMS message transmission between an MMS client and an MMS server.

Referring to FIG. 1, the MMS client 10 determines a reserved transmission time of an MMS message at an “X-Mms-Delivery-Time” field of the following Table 1 at step S1, and transmits the MMS message including the determined reserved transmission time to the MMS server 20 at step S2.

The following table 1 shows a Protocol Data Unit (PDU) for performing a reserved transmission function of the MMS message using the MMS client in 3GPP MM1 interface.

TABLE 1

| Information | | |
|---|---|---|
| element | Presence | Description |
| Message type | Mandatory | M-Send.req |
| Transaction ID | Mandatory | A unique identifier for the |
| | | message. |
| | | This transaction ID identifies |
| | | the M-Send.req and the |
| | | corresponding reply only. |
| MMS Version | Mandatory | MMS Service Version |
| X-Mms-Message-Class | Optional | |
| X-Mms-Expity | Optional | |
| X-Mms-Delivery-Time | Optional | Time at which MMS message |
| | | is to be transmitted to |
| | | message receiver |
| X-Mms-Priority | Optional | |
| X-Mms-Sender | Optional | |
| Visibility | | |
| X-Mms-Delivery- | Optional | |
| Report | | |
| X-Mms-Delivery- | Optional | |
| Reply | | |
| Content-Type | Mandatory | |

If the MMS server 20 successfully receives the MMS message from the MMS client, it assigns an ID (Identifier) to the above-mentioned reserved-transmission MMS message, and adds the assigned ID to a message ID field of the following Table 2 at step S4.

The MMS server 20 adds specific information indicating whether the MMS message is successfully received to the “Response Status” field shown in Table 2 at step S5.

The MMS server 20 transmits includes the ID of the aforementioned reserved-transmission MMS message and the aforementioned specific information indicating whether the MMS message is successfully received in a specific signal, and transmits the specific signal including the ID and the specific information to the MMS client 10 at step S6.

The MMS server 20 stores the received MMS message in its database, and determines whether a current time reaches a reserved transmission time prescribed in the MMS message at step S7. If the current time reaches the reserved transmission time at step S7, the MMS server 20 transmits the MMS message to a reception end at step S8.

The following Table 2 shows a Protocol Data Unit (PDU) for performing a reserved transmission function of the MMS message using the MMS server in 3GPP MM1 interface.

TABLE 2

| Information | | |
|---|---|---|
| element | Presence | Description |
| Message type | Mandatory | M-Send.conf |
| Transaction ID | Mandatory | A unique identifier for the |
| | | message. |
| | | This transaction ID identifies |
| | | the M-Send.req and the |
| | | corresponding reply only. |
| MMS Version | Mandatory | MMS Service Version |
| X-Mms-Response- | Mandatory | |
| Status | | |
| X-Mms-Response- | Optional | |
| Text | | |
| Message ID | Optional | Unique ID assigned to |
| | | MMS message. |
| | | MMS server assigns message ID |
| | | to MMS message when the MMS |
| | | message is accepted. |

However, an MM1 interface (i.e., a communication protocol for prescribing a transaction between the MMS client and the MMS server) prescribed in 3GPP does not prescribe a transaction capable of canceling a reserved transmission command of the reserved transmission message.

Therefore, the MMS client cannot transmit a reserved transmission cancellation command of the reserved transmission message formed by a reserved transmission function to the MMS server 20.

### SUMMARY OF THE INVENTION

Accordingly, the present invention is directed to a mobile terminal capable of canceling a reserved transmission of an MMS message and a method for use in the same that substantially obviate one or more problems due to limitations and disadvantages of the related art.

An object of the present invention is to provide a message transmission cancellation method for canceling a reserved transmission function of an MMS message, a mobile terminal, and a system thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal for canceling a reserved transmission of a multimedia message service (MMS) message comprising: a controller to receive a reserved transmission cancellation request of an MMS message, and generating a request signal to cancel the MMS message reserved transmission; and a transmitting unit to transmit the generated request signal to a message provision server.

In another aspect of the present invention, there is provided a method for canceling a reserved transmission of a multimedia message service (MMS) message of a mobile terminal comprising: transmitting a multimedia message service (MMS) message for reserved transmission to a message provision server; receiving a reserved transmission cancellation request of the reserved-transmitted MMS message, generating a reserved transmission cancellation request signal of the MMS message; and transmitting the reserved transmission cancellation request signal to the message provision server.

In yet another aspect of the present invention, there is provided a method for canceling a reserved transmission of a multimedia message service (MMS) message of a mobile terminal comprising: selecting a predetermined MMS message for canceling a reserved transmission function from among at least one reserved transmission MMS message; generating a reserved transmission cancellation request signal of the selected MMS message; and transmitting the generated request signal to a message provision server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments) of the invention and together with the description serve to explain the principle of the invention. In the drawings:

FIG. 1 is a flow chart illustrating a conventional reserved MMS message transmission between an MMS client and an MMS server;

FIG. 2 is a block diagram illustrating a mobile terminal capable of canceling a reserved transmission of an MMS message according to the present invention;

FIG. 3 is a block diagram illustrating a transmitting unit according to the present invention;

FIG. 4 is a flow chart illustrating a method for canceling a reserved transmission of an MMS message of a mobile terminal according to the present invention;

FIGS. 5a˜5e exemplarily show screen images for designating a method for canceling a reserved transmission of an MMS message of a mobile terminal according to the present invention;

FIG. 6 is a flow chart illustrating a method for canceling a reserved transmission of an MMS message of a message provision server according to the present invention; and

FIG. 7 is a block diagram illustrating a system capable of canceling a reserved transmission of an MMS message according to the present invention.

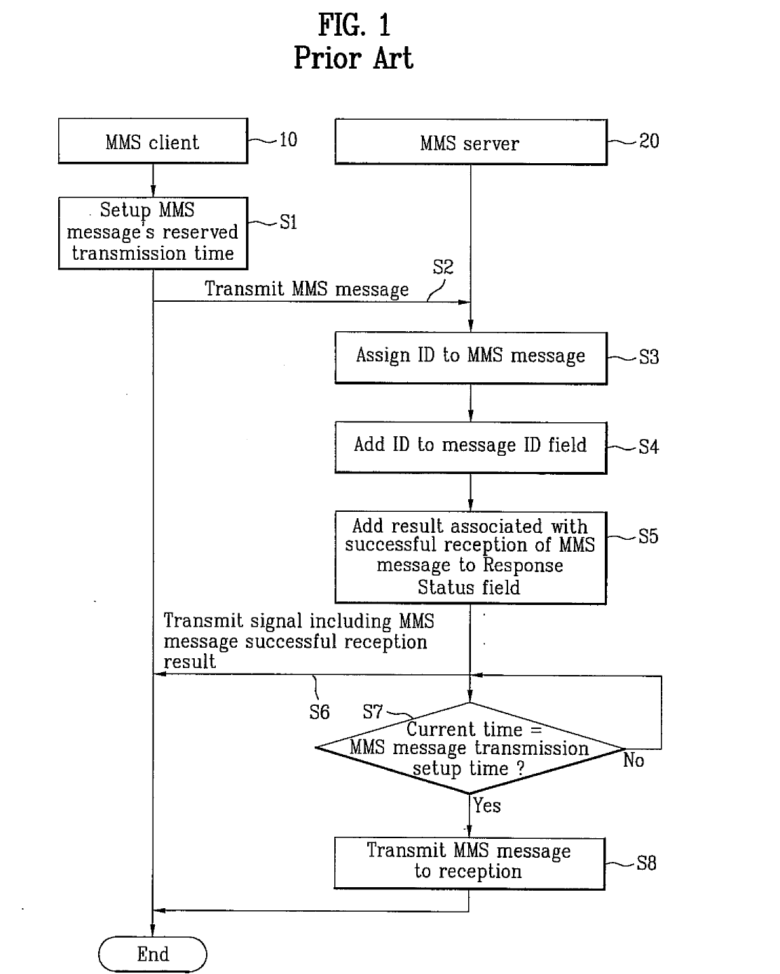

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A mobile terminal capable of canceling a reserved transmission of an MMS message and a method for use in the same according to the present invention will hereinafter be described with reference to the annexed drawings.

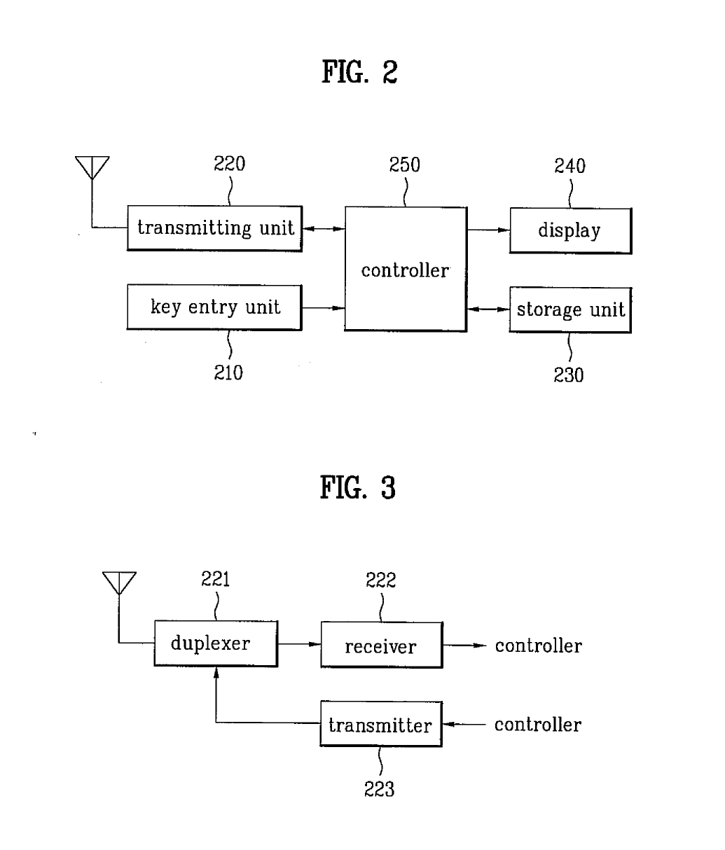

FIG. 2 is a block diagram illustrating a mobile terminal capable of canceling a reserved transmission of an MMS message according to the present invention.

Referring to FIG. 2, a key entry unit 210 serves as a user interface, includes a plurality of number keys and a plurality of function keys, and transmits different key signals associated with the aforementioned keys to a controller 250.

The key entry unit 210 may be configured in the form of a keypad for the mobile communication terminal, a touch-panel, or a touch-screen, etc.

The transmitting unit 220 modulates a reserved transmission request signal of an MMS message formed by a user into an RF signal, and transmits the RF signal to a message provision server.

The message provision server assigns an ID to the MMS message received from the transmitting unit 220, and transmits a reserved transmission result signal (ACK or NAK) including the aforementioned MMS message ID to the transmitting unit 220.

The transmitting unit 220 modulates the reserved transmission cancellation request signal of the MMS message formed by the controller 250 into an RF signal, and transmits the RF signal to the message provision server.

The transmitting unit 220 receives a reserved transmission cancellation result signal of the above-mentioned reserved transmission cancellation request signal from the message provision server.

The reserved transmission cancellation request signal and the reserved transmission cancellation result signal may be configured in the form of messages, such that the messages can be transmitted or received to/from the message provision server.

The transmitting unit 220 will hereinafter be described with reference to FIG. 3.

FIG. 3 is a block diagram illustrating a transmitting unit according to the present invention.

Referring to FIG. 3, the transmitting unit 220 includes a duplexer 221, a receiver 22, and a transmitter 223.

The duplexer 221, performs separation of an RF signal transmitted/received via an antenna (ANT).

The receiver 222 is controlled by the controller 250, receives the reserved transmission cancellation result signal from the duplexer 221, decodes the received reserved transmission cancellation result signal, and outputs the decoded result to the controller 250.

The transmitter 223 modulates the reserved transmission cancellation request signal of the MMS message formed by the controller 250 into an RF signal, and outputs the RF signal to the duplexer 221.

A storage unit 230 includes a predetermined program for controlling overall operations of the above-mentioned mobile terminal, and stores various Input/Output data units generated when the mobile terminal is controlled by the controller 250.

The storage unit 230 is determined to be at least one of an internal memory and an external memory of the mobile communication terminal.

Upon receiving a control signal from the controller 250, the storage unit 230 stores the reserved transmission cancellation request signal of the MMS message, and the reserved transmission result signal associate with the reserved transmission request signal of the MMS message.

The reserved transmission result signal includes ID information of the aforementioned MMS message.

A display 240 receives display data corresponding to a key signal received from the key entry unit 210 upon receiving a control signal from the controller 250, displays the received display data, and displays operation states of the mobile terminal and a plurality of information units thereof in the form of icons and characters.

The display 240 displays a list of reserved transmission MMS messages stored in the storage unit 230 upon receiving a control signal from the controller 250.

In addition, the display 240 displays a reserved transmission cancellation result signal associated with the aforementioned reserved transmission cancellation request signal of the MMS message.

The controller 250 controls overall operations of the above-mentioned mobile terminal.

A method for canceling a reserved transmission of an MMS message according to the present invention will hereinafter be described in detail.

If the controller 250 receives a specific key signal for canceling a reserved transmission of a specific MMS message from among the reserved transmission MMS messages from the key entry unit 210, it creates a request signal for canceling a reserved transmission of the specific MMS message.

Preferably, the above-mentioned request signal may be configured in the form of various formats.

A method for creating the above-mentioned request signal of the controller 250 using the format prescribed in the 3GPP MM1 interface will hereinafter be described in detail.

The following Table 3 shows an exemplary format of the above-mentioned request signal for canceling a reserved transmission of an MMS message.

TABLE 3

| Information | | |
|---|---|---|
| element | Presence | Description |
| Message type | Mandatory | Field indicative of reserved |
| | | transmission cancellation |
| | | request signal |
| Transaction ID | Mandatory | Field for adding reserved |
| | | transmission cancellation |
| | | request signal ID |
| MMS Version | Mandatory | Field indicative of MMS |
| | | message version |
| Message ID | Mandatory | Field for adding ID of |
| | | MMS message whose reserved |
| | | transmission is to be |
| | | cancelled |

With reference to Table 3, when the message provision server receives a specific signal from the mobile communication terminal, the message-type field informs the message provision server that the specific signal is equal to the reserved transmission cancellation request signal.

The transaction ID field is indicative of a field for adding ID information of the reserved transmission cancellation request signal.

The reserved transmission cancellation request signal ID is indicative of an ID for identifying reserved transmission cancellation request signals of the reserved transmission MMS messages stored in the storage unit 230.

The MMS version field designates service version information of the MMS message.

The message ID field is indicative of a field for adding ID information of the MMS message whose reserved transmission is to be cancelled.

The controller 250 transmits the MMS message's reserved transmission cancellation request signal (i.e., M-Cancel.req) configured in the form of Table 3 to the message provision server via the transmitting unit 220.

The controller 250 receives the reserved transmission cancellation result signal associated with the reserved transmission cancellation request signal of the MMS message from the message provision server via the transmitting unit 220.

The following Table 4 shows an exemplary format of the reserved transmission cancellation result signal of the MMS message according to the present invention.

The following Table 4 shows a Protocol Data Unit (hereinafter referred to as an “M-Cancel.conf”) newly defined when the message provision server transmits the reserved transmission cancellation result signal to the mobile terminal.

TABLE 4

| Information | | |
|---|---|---|
| element | Presence | Description |
| Message type | Mandatory | Field indicative of reserved |
| | | transmission cancellation |
| | | result signal |
| Transaction ID | Mandatory | Field for adding reserved |
| | | transmission cancellation |
| | | result signal ID |
| MMS Version | Mandatory | Field indicative of MMS |
| | | message version |
| Request Status | Mandatory | Field for adding reserved |
| | | transmission cancellation |
| | | result content |

With reference to Table 4, when the mobile terminal receives a specific signal from the mobile provision server, the message-type field informs the mobile terminal that the specific signal is equal to the reserved transmission cancellation result signal.

The transaction ID field is indicative of a field for adding ID information of the reserved transmission cancellation result signal.

The reserved transmission cancellation result signal ID has the same value as that of the reserved transmission cancellation request signal ID.

The MMS version field designates service version information of the MMS message.

The request status field is indicative of a field for adding the reserved transmission cancellation result content.

The controller 250 stores the received reserved transmission cancellation result signal in the storage unit 230, and analyzes the aforementioned result content added to the request status field of the reserved transmission cancellation result signal.

The controller 250 displays the analyzed result content on the display 240.

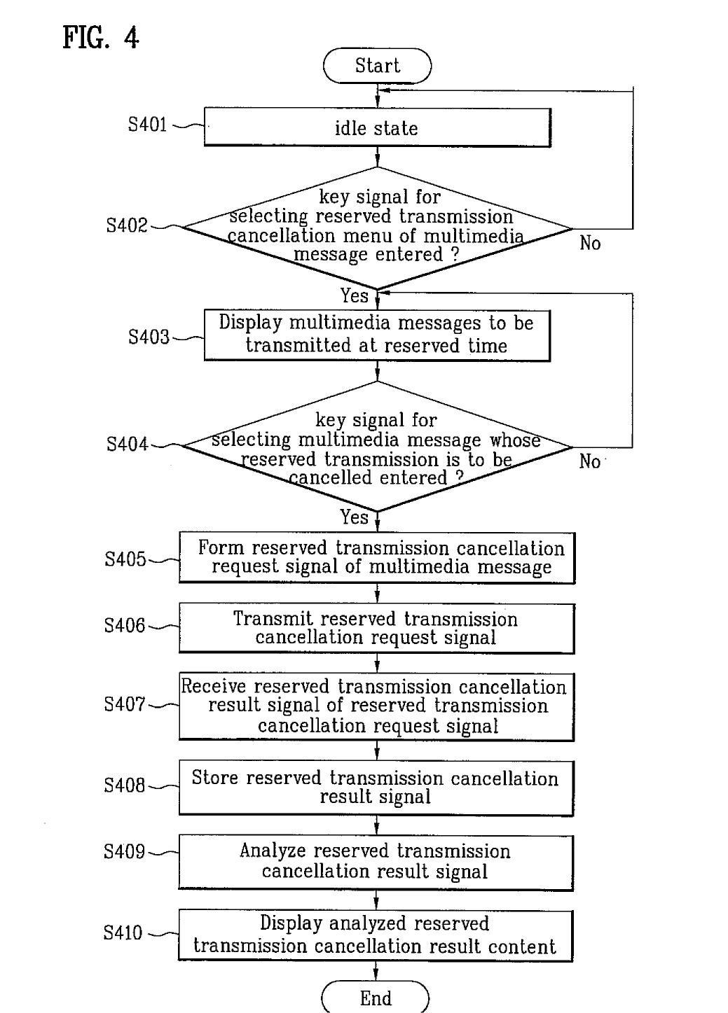

FIG. 4 is a flow chart illustrating a method for canceling a reserved transmission of an MMS message of a mobile terminal according to the present invention.

Referring to FIG. 4, if a user selects a specific menu for canceling a reserved transmission function of a specific MMS message using the key entry unit 210 at step S402 when the mobile terminal enters an idle state at step S401, the controller 250 of the mobile terminal retrieves MMS messages to be transmitted at reserved time(s) from the storage unit 230, and displays the list of the MMS messages on the display 240 at step S403.

If the user selects the specific MMS message, reserved transmission of which is to be cancelled, from the list of the MMS messages via the key entry unit 210 at step S404, the controller 250 forms a request signal for canceling the reserved transmission (i.e., a reserved transmission cancellation request signal) of the selected MMS message in the form of Table 3 at step S405.

The controller 250 transmits the formed reserved transmission cancellation request signal to the message provision server via the transmitting unit 220 at step S406.

If the controller receives the reserved transmission cancellation result signal associated with the reserved transmission cancellation request signal via the transmitting unit 220 at step S407, it stores the reserved transmission cancellation result signal in the storage unit 230 at step S408, and analyzes the aforementioned result content added to the request status field from among fields of the reserved transmission cancellation result signal at step S409. In this case, the format of the above-mentioned reserved transmission cancellation result signal is shown in Table 4.

The controller 250 displays the analyzed result content on the display 240.

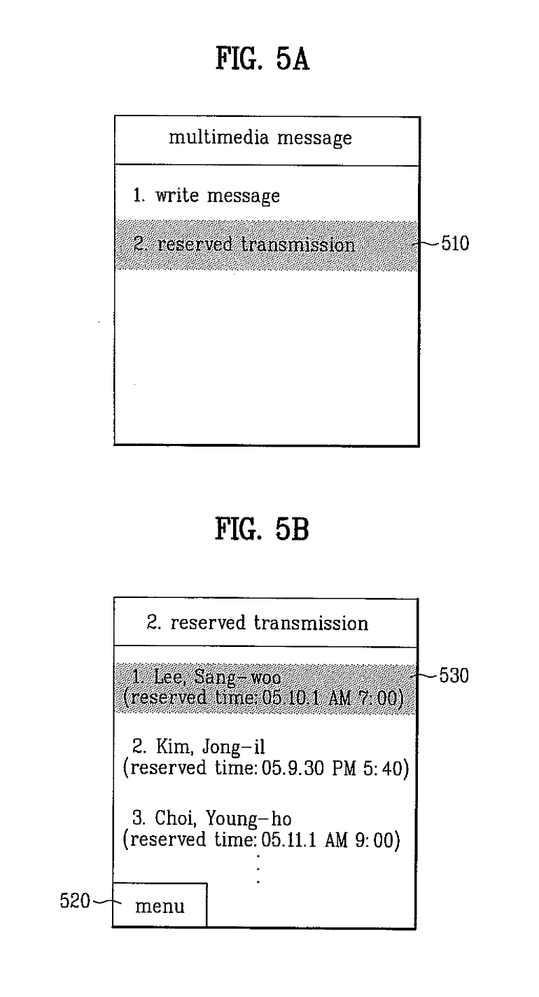

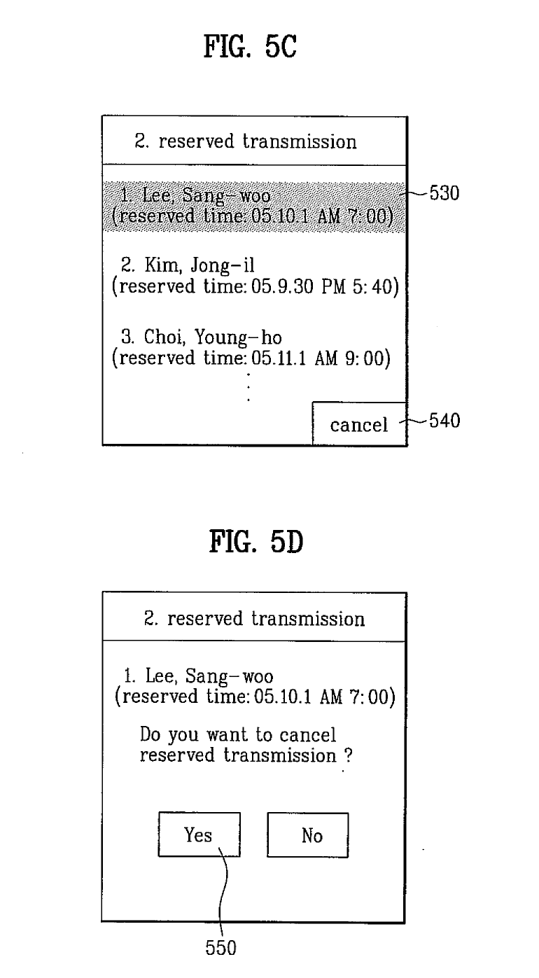

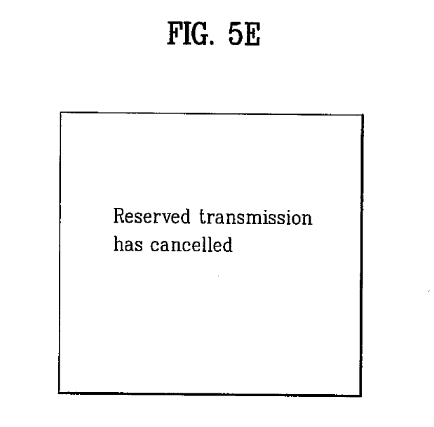

FIGS. 5a˜5e exemplarily show screen images for designating a method for canceling a reserved transmission of an MMS message of a mobile terminal according to the present invention.

Referring to FIGS. 5a˜5d, if a user presses a predetermined key to select a reserved transmission menu 510 from among MMS message menu items as shown in FIG. 5a, the mobile terminal displays the list of MMS messages to be transmitted at reserved time(s) on a screen image as shown in FIG. 5b.

If the user presses a menu key 520, the mobile terminal displays a cancel key 540 to cancel a specific MMS message 530 to be cancelled from among the list of the aforementioned MMS message on a screen image as shown in FIG. 5c.

If the user presses the cancel key 540 to select a specific MMS message 530 to be cancelled from among the list of the aforementioned MMS messages, the mobile terminal displays a reserved transmission cancellation window of the selected MMS message 530 on a screen image as shown in FIG. 5d.

If the user presses a predetermined key 550 to cancel the reserved transmission of the selected MMS message 530 on the aforementioned reserved transmission cancellation window, the mobile terminal forms a request signal for canceling the reserved transmission of the selected MMS message 530, and transmits the request signal to the message provision server.

The mobile terminal receives a reserved transmission cancellation result signal associated with the reserved transmission cancellation request signal from the message provision server, analyzes the received reserved transmission cancellation result signal, and displays the analyzed result content on a screen image as shown in FIG. 5e.

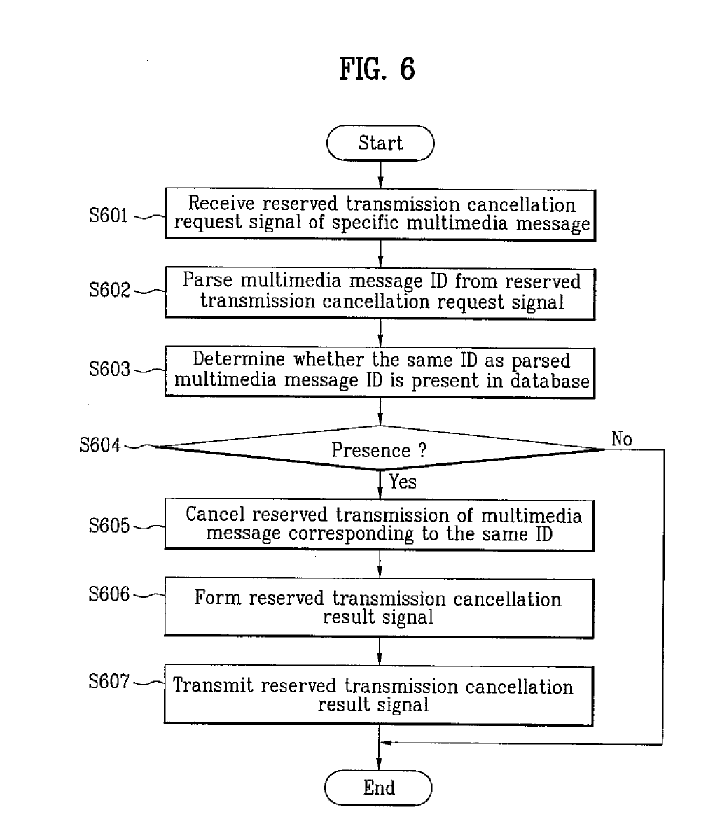

FIG. 6 is a flow chart illustrating a method for canceling a reserved transmission of an MMS message of a message provision server according to the present invention.

Referring to FIG. 6, the message provision server receives the reserved transmission cancellation request signal of a specific MMS message from the mobile terminal at step S601.

The message provision server parses the MMS message ID from the reserved transmission cancellation request signal at step S602.

The message provision server parses the MMS message ID added to the message ID field of the reserved transmission cancellation request signal.

The message provision server determines whether the same ID as the parsed MMS message ID is present in a database at step S603.

If the same ID as the parsed MMS message ID is contained in the database at step S604, the message provision server cancels the reserved transmission of the MMS message corresponding to the same ID at step S605.

If a predetermined period of time elapses under the condition that the reserved transmission of the MMS message is cancelled, the message provision server deletes the above MMS message associated with the cancelled reserved transmission, such that storage capacitance of the database can be increased.

The message provision server configures the reserved transmission cancellation result signal associated with the reserved transmission cancellation request signal in the form of Table 4 at step S606.

The message provision server transmits the above-mentioned reserved transmission cancellation result signal to the mobile terminal at step S607.

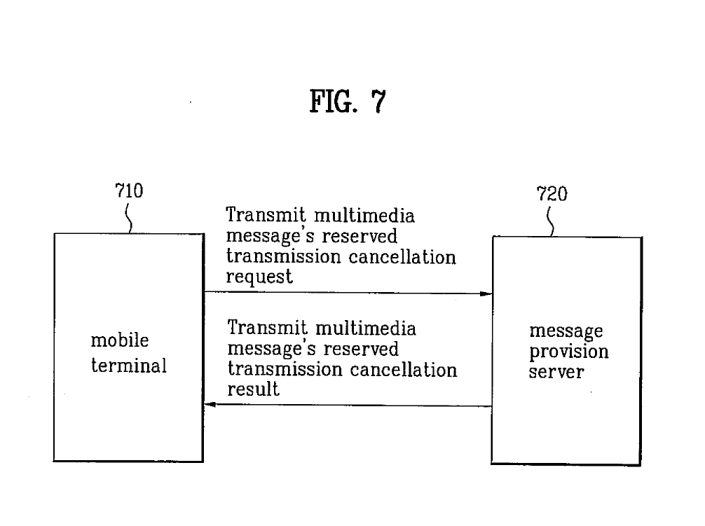

FIG. 7 is a block diagram illustrating a system for canceling a reserved transmission of an MMS message according to the present invention.

Referring to FIG. 7, the mobile terminal 710 configures a reserved transmission cancellation request signal of a specific MMS message whose reserved transmission is to be cancelled in the form of Table 3, and transmits the reserved transmission cancellation request signal to the message provision sever 720.

The message provision server 720 receives the reserved transmission cancellation request signal from the mobile terminal 710, and parses the MMS message ID from the received reserved transmission cancellation request signal.

The message provision server 720 determines whether the same ID as the parsed MMS message ID is present in a database. If the same ID as the parsed MMS message ID is contained in the database, the message provision server 720 cancels the reserved transmission of the MMS message corresponding to the same ID.

If a predetermined period of time elapses under the condition that the reserved transmission of the MMS message is cancelled, the message provision server 720 deletes the above MMS message associated with the cancelled reserved transmission, such that storage capacitance of the database can be increased.

The message provision server 720 configures the reserved transmission cancellation result signal associated with the reserved transmission cancellation request signal in the form of Table 4.

The message provision server transmits the above-mentioned reserved transmission cancellation result signal to the mobile terminal 710.

The mobile terminal 710 receives the reserved transmission cancellation result signal from the message provision server 720, and stores the received reserved transmission cancellation result signal.

The mobile terminal 710 analyzes the reserved transmission cancellation result content added to the request status field of the reserved transmission cancellation result signal, and displays the analyzed result content.

As apparent from the above description, a message transmission cancellation method, a mobile terminal, and a system thereof according to the present invention implement a reserved transmission cancellation function of an MMS message differently from the conventional art, such that more convenient MMS message services can be supplied to user(s).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal for canceling a reserved transmission of a multimedia message service (MMS) message comprising:
a controller to receive a reserved transmission cancellation request of an MMS message, and generating a request signal to cancel the MMS message reserved transmission; and
a transmitting unit to transmit the generated request signal to a message provision server.

2. The mobile terminal according to claim 1, wherein the controller generates the request signal to include at least one of information, to indicate that the request signal serves as a signal to cancel the reserved transmission of the MMS message, and identifier (ID) information of the reserved-transmitted MMS message.

3. The mobile terminal according to claim 1, wherein the controller receives a MMS reserved transmission cancellation result signal associated with the request signal from the message provision server via the transmitting unit.

4. The mobile terminal according to claim 1, wherein the message provision server parses ID information of the MMS message contained in the request signal, determines whether the same ID as the parsed MMS message ID is present, cancels a reserved transmission of the MMS message corresponding to the same ID when the same ID as the parsed MMS message ID is present, and transmits the MMS reserved transmission cancellation result signal to the mobile communication terminal.

5. The mobile terminal according to claim 3, wherein the result signal includes at least one of information, to indicate that the request signal serves as the MMS reserved transmission cancellation result signal, and content information of the MMS reserved transmission cancellation result signal.

6. The mobile terminal according to claim 1, further comprising a display unit to display a menu, wherein the menu is to cancel the reserved transmission of the MMS message.

7. The mobile terminal according to claim 6, wherein the menu to provide a list of the reserved transmission of the MMS messages, wherein at least one of the reserved transmission of the MMS message can be cancelled by selection.

8. A method for canceling a reserved transmission of a multimedia message service (MMS) message of a mobile terminal comprising:
transmitting a multimedia message service (MMS) message for reserved transmission to a message provision server;
receiving a reserved transmission cancellation request of the reserved-transmitted MMS message, generating a reserved transmission cancellation request signal of the MMS message; and
transmitting the reserved transmission cancellation request signal to the message provision server.

9. The method according to claim 8, wherein the receiving step comprising:
generating the request signal including at least one of information, indicating that the request signal serves as a signal for canceling the reserved transmission of the MMS message, and identifier (ID) information of the reserved-transmitted MMS message.

10. The method according to claim 8, further comprising:
receiving an MMS reserved-transmission cancellation result signal associated with the request signal from the message provision server;
analyzing result content information added to a specific field of the received result signal; and
displaying the analyzed result content information.

11. The method according to claim 8, wherein the message provision server parses an ID of the MMS message contained in the request signal, determines whether the same ID as the parsed MMS message ID is present, cancels a reserved transmission of the MMS message corresponding to the same ID when the same ID as the parsed MMS message ID is present, and transmits the reserved transmission cancellation result signal to the mobile terminal.

12. The method according to claim 10, wherein the result signal includes at least one of information, indicating that the request signal serves as the MMS reserved transmission cancellation result signal, and content information of the MMS reserved transmission cancellation result signal.

13. A method for canceling a reserved transmission of a multimedia message service (MMS) message of a mobile terminal comprising:
selecting a predetermined MMS message for canceling a reserved transmission function from among at least one reserved transmission MMS message;
generating a reserved transmission cancellation request signal of the selected MMS message; and
transmitting the generated request signal to a message provision server.
